(19) United States
(12) Patent Application Publication
(10) Pub. No.: US 2008/0111667 A1
(43) Pub. Date: May 15, 2008

(54) SYSTEM FOR SIMPLIFIED TRAILER DRIVER COMMUNICATION AND A METHOD OF OPERATING THE SAME

(75) Inventors: Patricia Denise Mackenzie, Clifton Park, NY (US); Douglas Roy Forman, Ballston Lake, NY (US); Andrew John Calver, Westwood, CA (US); Morgan Fredric Intrator, Nashville, TN (US); Robert August Graziano, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC, Schenectady, NY (US)

(21) Appl. No.: 11/559,977

(22) Filed: Nov. 15, 2006

(51) Int. Cl. G08B 21/18

(52) U.S. Cl. 340/431

(57) ABSTRACT

A device mounted on a tractor trailer is disclosed. The device includes at least one input from a sensor input device or at least one external communication device. The device further includes a receiver configured to receive an incoming data via either the sensor input device or the external communication device. The device also includes a processor configured to generate an alert message to be associated with the trailer on which the system is mounted. The device also includes a transmitter configured to broadcast a signal containing the alert message.

### BACKGROUND

The present invention relates generally to wireless communication, and more specifically to wireless communication in a driver services market.

Several modes of transportation exist for delivering goods from one place to another. Some of the commonly used modes are trailers, cargo containers shipped by boat, and rail boxcars. A driver is seated in a cab in front of the tractor trailer, the boat or the train in each of these cases and the goods are placed in the trailer, the cargo container and the boxcar respectively.

Communication to the driver transporting the goods is desirable for various reasons. Some of the common reasons include alerting the driver of extreme weather conditions and traffic alerts, obtaining information regarding condition of the trailer such as tire pressure, and also providing information regarding the goods being carried, such as temperature of the goods.

One technique of transmitting information from the cargo unit to the driver in a cab of a tractor trailer, as an example, is through a wired connection to an electronic receiver installed in the cab that communicates information to the driver seated in the cab.

However, such techniques are inefficient and expensive as they require installation of a dedicated device in each cab that needs to receive communication. Further, it is commonly observed that the same tractor cab is used with trailers from different companies, each of which may use a different type of sensor input device. Hence, in order to operate with trailers belonging to different companies, the tractor may require multiple such dedicated receiving devices, unless each trailer company uses the same dedicated device for communication.

Therefore, there is a need for an improved communication system to address the aforementioned issues.

### BRIEF DESCRIPTION

In accordance with an embodiment of the invention, a device mounted on a trailer is provided. The device includes at least one input from a sensor input device or at least one external communication device. The device also includes a receiver configured to receive an incoming data via either the sensor input device or the external communication device. The device further includes a processor configured to generate an alert message to be associated with the trailer on which the system is mounted. The device also includes a transmitter configured to broadcast a signal containing the alert message to a cab in the tractor trailer.

In accordance with another embodiment of the invention, a system for communication is provided. The system includes a remote hub. The system also includes a receiver in a cab of the tractor trailer configured to receive a wireless signal containing an alert message from the remote hub.

In accordance with another embodiment of the invention, a method of operation is provided. The method includes receiving a signal corresponding to an incoming data via a remote hub. The method also includes determining if the incoming data needs to be compared with a preset data threshold. The method further includes transmitting the incoming data to a receiver in a cab of a tractor trailer if no comparison is needed. The method also includes comparing the incoming data with the preset data threshold if a comparison is needed. The method also includes determining if an alert message should be made based upon comparison. The method also includes producing the alert message. The method further includes broadcasting the alert message to the receiver in the cab of the tractor trailer.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of a trailer truck system with a simplified communication system;

FIG. 2 is a block diagram representation of communications protocol in the trailer truck system in FIG. 1;

FIG. 3 is a block diagram representation of components in the remote hub in FIG. 1; and

FIG. 4 is a flow chart illustrating exemplary steps for a method of operation of the simplified communication system in FIG. 1.

### DETAILED DESCRIPTION

As discussed in detail below, embodiments of the present invention include a system for simplified communication and a method of operating the same. As used herein, ‘simplified communication’ refers to communication from a trailer or cargo unit that may contain an inventory of goods and the driver in a cab of a vehicle associated with the trailer or cargo unit. Various kinds of information may be needed to be transmitted to a driver or a cab from the trailer. Some non-limiting examples of such information may include inventory related data such as real time temperature of the inventory and the physical loads that the inventory is subject to during transport. In another example, the information may be related to condition of the trailer such as tire pressure and condition of bearings. Back offices and control stations that track trailers may also generally need to communicate information to drivers of such vehicles. Some non-limiting examples of the information may include location based information such as traffic alerts, locations of nearby restaurants, and weather related information. Some non-limiting examples of the vehicles may include trailer trucks and cargo ships.

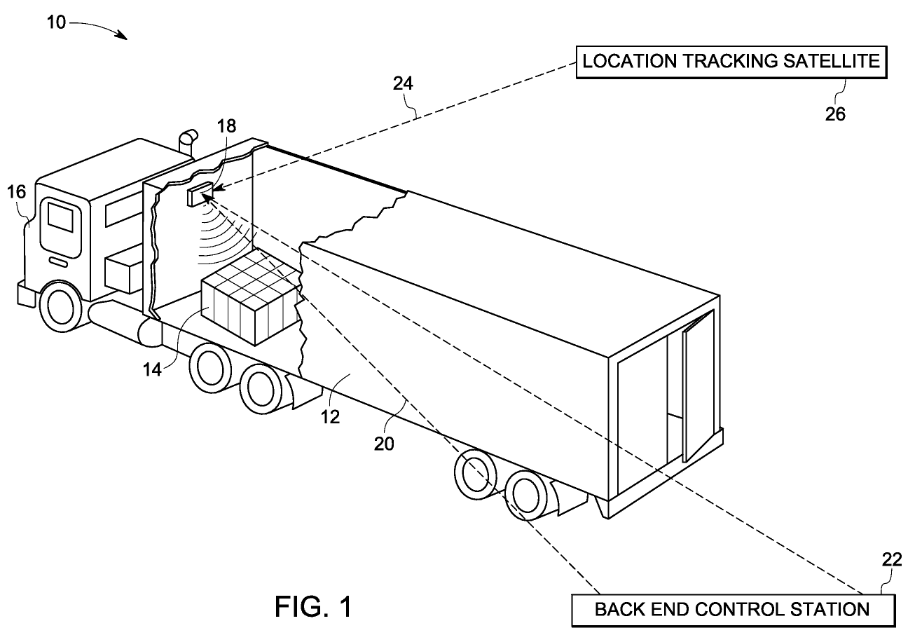

FIG. 1 is a diagrammatic illustration of a trailer system 10 with a simplified communication system. The system 10 includes a trailer 12 carrying goods 14 and a cab 16 attached to a front end of the trailer 12 having a driver. A remote hub 18 is located in the trailer 12. The remote hub 18 is configured to receive wireless signals 20 from a back end control station 22. The remote hub 18 may also receive wireless signals 24 about location information via a location tracking satellite 26. A non-limiting example of a location tracking satellite 26 may include a global positioning satellite (GPS). In another embodiment, the location information may be provided by a non-satellite source. The remote hub 18 further transmits wireless signals to the cab 16 to relay information received via the wireless signals 20 and 24 respectively. One example of such a remote hub 18 is a VeriWise™ hub, produced by the General Electric Company.

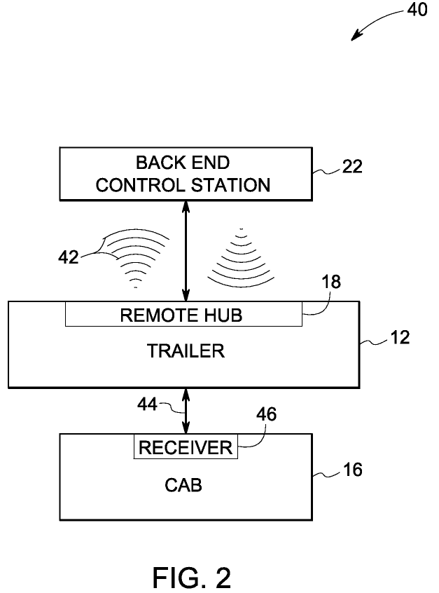

FIG. 2 is a block diagram representation 40 of a communications protocol in the tractor trailer system 10 in FIG. 1. When a message needs to be communicated to a driver of the tractor trailer system 10, the back end control station 22 as referenced in FIG. 1, sends a wireless signal 42 to the trailer 12 as referenced in FIG. 1. The signal 42 is transmitted to the remote hub 18 as referenced in FIG. 1, located in the trailer 12. The remote hub 18 further transmits a signal 44 to a receiver 46 situated in the cab 16 as referenced in FIG. 1. The signal 44 is relayed to the driver in the cab 16 via various modes. In an example, the signal 44 may be an alert relayed as a text message. In another example, the signal 44 may be an alert relayed as a voice message. In a particular embodiment, the driver may hear a voice message over a FM radio station. In another embodiment, the signal 44 may be transmitted over a XM radio signal. In yet another embodiment, the signal 44 may be a low power radio signal. In another example, the signal 44 may be transmitted as a WiFi signal. In a specific embodiment, the signal 44 may be transmitted from a RFID tag corresponding to a specific trailer.

The back end control station 22 may communicate various types of information to the driver through the remote hub 18. In a particular embodiment, the back end control station 22 may send a weather alert signal to the remote hub 18 that is to be communicated to the driver. In another embodiment, the back end control station 22 may send an alert signal regarding traffic delays on relevant routes to the remote hub 18 that forwards the same to the driver. In another embodiment, a message may be transmitted directly from the trailer 12 to the cab 16. A non-limiting example of the message may include tire pressure of the trailer. In yet another embodiment, a message may be transmitted directly from inventory in the trailer 12 to the cab 16. A non-limiting example of the message may include temperature of the inventory.

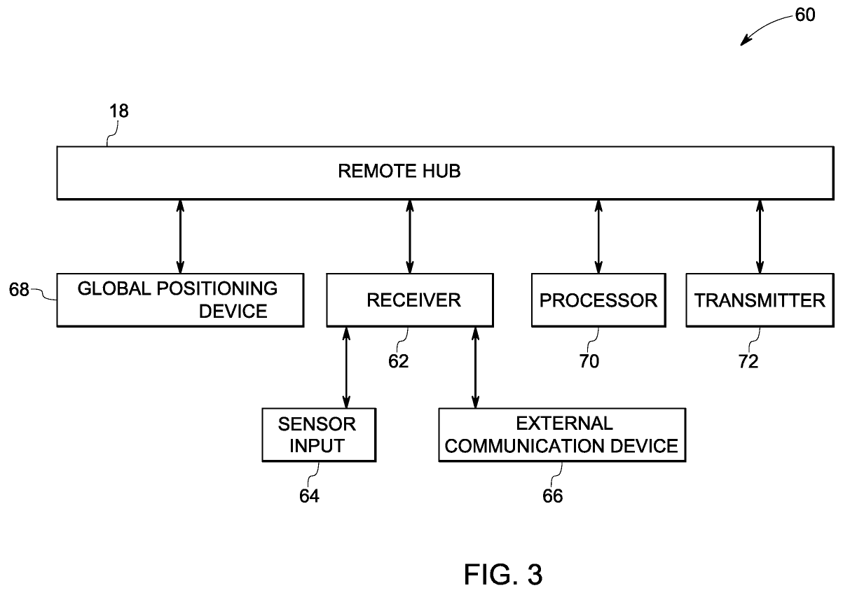

FIG. 3 is a block diagram representation 60 of components in the remote hub 18 in FIG. 1. The remote hub 18 may include a receiver 62 to receive a signal corresponding to incoming data via either a sensor input device 64 or an external communication device 66. In an example, the incoming data may be temperature data indicating the temperature in a trailer. In another example, the incoming data may correspond to tire pressure of one or more of the tires on the trailer. A global positioning (GPS) device 68 may also be coupled to the remote hub 18 to receive position data regarding location of the trailer. Depending on whether a preset boundary condition has been reached, an alert message may be generated via a processor 70 in the remote hub 18. In a particular embodiment, the processor 70 may be a general purpose processor that may also be configured to perform various datakeeping and control functions, such as trend analysis and data storage. In other embodiments, dedicated processors may also be used. A transmitter 72 coupled to the remote hub 18 broadcasts a signal containing the alert message to a cab.

The remote hub 18 may also be used to transmit various types of information pertaining to the trailer to a driver. In a particular embodiment, the remote hub 18 may sense that temperature of surrounding air has exceeded a critical or a preset temperature of perishable goods being shipped via a temperature sensor. In such a case, the remote hub 18 sends an alert message to the driver informing him about the same. In another embodiment, the remote hub 18 may sense the pressure in one of the tires to be lower than a desired value via a pressure sensor. In such a case, the remote hub 18 may transmit an alert message to the driver regarding the same. In yet another embodiment, the remote hub 18 may receive a signal about a door being open via a sensor attached on a door. In such a case, the remote hub 18 sends a corresponding alert message to the driver. In another example, the remote hub 18 may send an alert message regarding humidity in the trailer reaching a critical value.

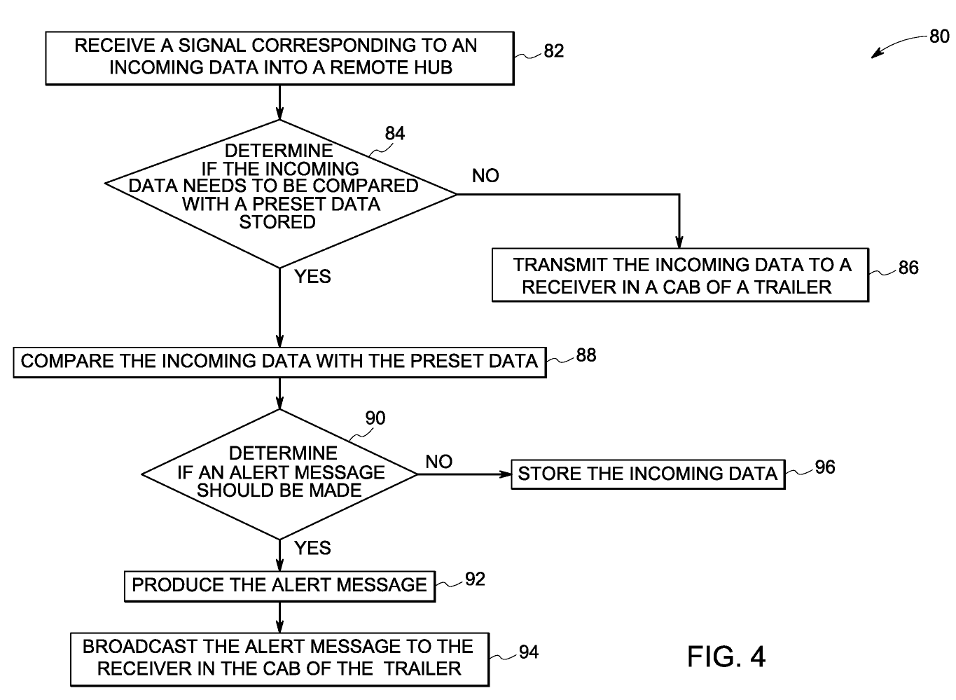

FIG. 4 is a flow chart illustrating exemplary steps for a method 80 of operation of a simplified communication system. The method 80 includes receiving a signal corresponding to incoming data into a remote hub located in a trailer of a tractor trailer in step 82. In a particular embodiment, the signal may be received by the remote hub from a GEO satellite. In another embodiment, the signal may be received by the remote hub from a LEO satellite. In yet another embodiment, the signal may be received by the remote hub from a satellite radio or a cellular radio. In another embodiment, the signal may be received from a sensor in the trailer or on an inventory. Once the signal is received, it is to be determined in step 84 if the incoming data is such that it needs to be compared with a preset data threshold. In an example, the incoming data may be a traffic alert from a back end control station that does not need to be compared. In another example, the incoming data may be temperature within a trailer that needs to be compared with a preset temperature needed to preserve goods in the trailer. The incoming data is transmitted to a receiver in a cab of a tractor trailer in step 86, if no comparison is needed. If a comparison is needed, the incoming data is compared with the preset data threshold in step 88. A decision is made in a processor if an alert message is to be generated in step 90 based upon comparison. If the incoming data exceeds a limit corresponding to the preset data, an alert message is produced in step 92. In an example, the alert message is produced by converting the signal received to a text message. In another example, the alert message is produced by converting the signal received to a voice message. The alert message is further broadcasted to a receiver in the cab of the tractor trailer in step 94. In a particular embodiment, the alert message may be broadcasted via a FM radio signal. In another embodiment, the alert message may be broadcasted via a XM radio signal. In another example, the alert message may be broadcasted via a WiFi signal. If an alert message need not be generated in step 90, the incoming data is stored in the remote hub in step 96.

In an example of such a simplified trailer driver communication, a weather alert may be transmitted to a driver in a cab of a tractor trailer as a voice message via a FM signal. An example of such a voice message may be “Communication system must interrupt this satellite radio broadcast with a message from your dispatcher. On route to your next destination, there is a 70 percent chance of heavy thunderstorms along highway 90 East between exits 23-34 leading to extensive delays. For detour information, please consult your visual map display.” In another example, an alert regarding temperature may be broadcasted to the driver in the cab via a WiFi signal onto a handheld device with a text message such as “Communication system must interrupt with this message. The temperature in the trailer has reached the critical temperature.”

The various embodiments of a system for simplified communication and a method of operating the same described above thus provide a way to achieve a low cost and efficient communication from a cargo unit such as a trailer to a driver in a cab of a trailer truck system. These techniques and systems also allow a communication system with minimal modification to an existing infrastructure.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a text alert message to communicate to a driver in a cab of a trailer truck described with respect to one embodiment can be adapted for use with an alert message being transmitted via FM radio described with respect to another. Similarly, the various features described, as well as other known equivalents for each feature, can be mixed and matched by one of ordinary skill in this art to construct additional systems and techniques in accordance with principles of this disclosure.

Although the systems herein have been disclosed in the context of certain preferred embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A device mounted on a trailer of a tractor trailer comprising:
at least one sensor input device or one external communication device
a receiver configured to receive an incoming data via either the sensor input device or the external communication device;
a processor configured to generate an alert message to be associated with the trailer on which the system is mounted; and
a transmitter configured to broadcast a signal containing the alert message to a cab in the tractor trailer.

2. The device of claim 1, further comprising a position sensing device configured to send position data to the processor.

3. The device of claim 2, wherein the position sensing device is a global positioning device.

4. The device of claim 1, wherein the sensor input device comprises a temperature sensor, a pressure sensor or a humidity sensor.

5. The device of claim 1, wherein the incoming data comprises a text message.

6. The device of claim 1, wherein the incoming data comprises a voice message.

7. The device of claim 1, wherein the alert message comprises a text message.

8. The device of claim 1, wherein the alert message comprises a voice message.

9. The device of claim 1, wherein the signal to be broadcasted to the cab comprises a signal transmitted via a FM radio signal, XM radio signal or WiFi signal.

10. The device of claim 1, wherein the signal to be broadcasted to the cab comprises a signal transmitted from a radio frequency ID tag.

11. The device of claim 1, wherein the incoming data received by the receiver comprises incoming data transmitted over a GEO satellite, a LEO satellite, a satellite radio or a cellular radio.

12. A system for communication comprising:
a remote hub; and
a receiver in a cab of the tractor trailer configured to receive a wireless signal containing an alert message from the remote hub.

13. The system of claim 12, further comprising a plurality of sensors disposed in a trailer of the tractor trailer configured to transmit data to the remote hub.

14. The system of claim 12, further comprising a back end control station configured to transmit a message to the remote hub for presentation to the receiver in a cab.

15. The system of claim 12, wherein the signal is transmitted over a GEO satellite, a LEO satellite, a satellite radio or a cellular radio.

16. The system of claim 12, wherein the alert message comprises a text message.

17. The system of claim 12, wherein the alert message comprises a voice message.

18. The system of claim 12, wherein the alert message is transmitted from a radio frequency ID tag.

19. The system of claim 12, wherein the signal containing the alert message comprises a signal transmitted from the remote hub via a FM radio signal, XM radio signal or a WiFi signal.

20. A method of operation comprising:
receiving a signal corresponding to an incoming data via a remote hub;
determining if the incoming data needs to be compared with a preset data threshold;
transmitting the incoming data to a receiver in a cab of a tractor trailer if no comparison is needed;
comparing the incoming data with the preset data threshold if a comparison is needed;
determining if an alert message should be made based upon comparison;
producing the alert message; and
broadcasting the alert message to the receiver in the cab of the tractor trailer.

21. The method of claim 20, wherein receiving a signal comprises receiving via a GEO satellite, a LEO satellite, a satellite radio or a cellular radio.

22. The method of claim 20, wherein producing the alert message comprises converting the signal received to a text message.

23. The method of claim 20, wherein producing the alert message comprises converting the signal received to a voice message.

24. The method of claim 20, wherein broadcasting the alert message comprises broadcasting as a FM radio signal, XM radio signal or a WiFi signal.
